(19) United States
(12) Patent Application Publication
(10) Pub. No.: US 2007/0097571 A1
(43) Pub. Date: May 3, 2007

(54) Multiphase voltage regulation using paralleled inductive circuits having magnetically coupled inductors

(75) Inventors: James S. Dinh, Gig Harbor, WA (US); Robert D. Wickersham, Roy, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 11/177,163

(22) Filed: Jul. 7, 2005

(51) Int. Cl. H02H 3/00

(52) U.S. Cl. 361/62

(57) ABSTRACT

For one disclosed embodiment, phased control signals are generated, and pulsed signals are generated in response to generated phased control signals. Generated pulsed signals are received by multiple inductive circuits having magnetically coupled inductors. An inductive circuit receives pulsed signals corresponding to different phases. Multiple inductive circuits receive a pulsed signal corresponding to the same phase. Received pulsed signals are combined by multiple inductive circuits to generate an output signal. Other embodiments are also described and claimed.

### FIELD

Embodiments described in this patent application generally relate to voltage regulation.

### BACKGROUND

Some integrated circuits are designed to operate using relatively lower supply voltages to help reduce power consumption. A voltage regulator may be used, for example, to convert a supply voltage signal from a power supply into a lower, regulated supply voltage signal for use by an integrated circuit. A voltage regulator is also to have sufficient current-carrying capacity to deliver the current drawn by the integrated circuit.

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, a block diagram of a voltage regulator having paralleled inductive circuits having magnetically coupled inductors;

FIG. 2 illustrates, for one embodiment, a flow diagram to regulate voltage using paralleled inductive circuits having magnetically coupled inductors;

FIG. 3 illustrates, for one embodiment, example switching circuitry and combining circuitry for the voltage regulator of FIG. 1;

FIG. 4 illustrates, for one embodiment, a waveform diagram of example signal waveforms for the voltage regulator of FIG. 3;

FIG. 5 illustrates, for another embodiment, example switching circuitry and combining circuitry for the voltage regulator of FIG. 1;

FIG. 6 illustrates, for one embodiment, example control circuitry for the voltage regulator of FIG. 1; and

FIG. 7 illustrates, for one embodiment, an example system comprising a voltage regulator having paralleled inductive circuits having magnetically coupled inductors.

### DETAILED DESCRIPTION

The following detailed description sets forth example embodiments of methods, apparatuses, and systems relating to multiphase voltage regulation using paralleled inductive circuits having magnetically coupled inductors. Features, such as structure(s), function(s), and/or characteristic(s) for example, are described with reference to one embodiment as a matter of convenience; various embodiments may be implemented with any suitable one or more described features.

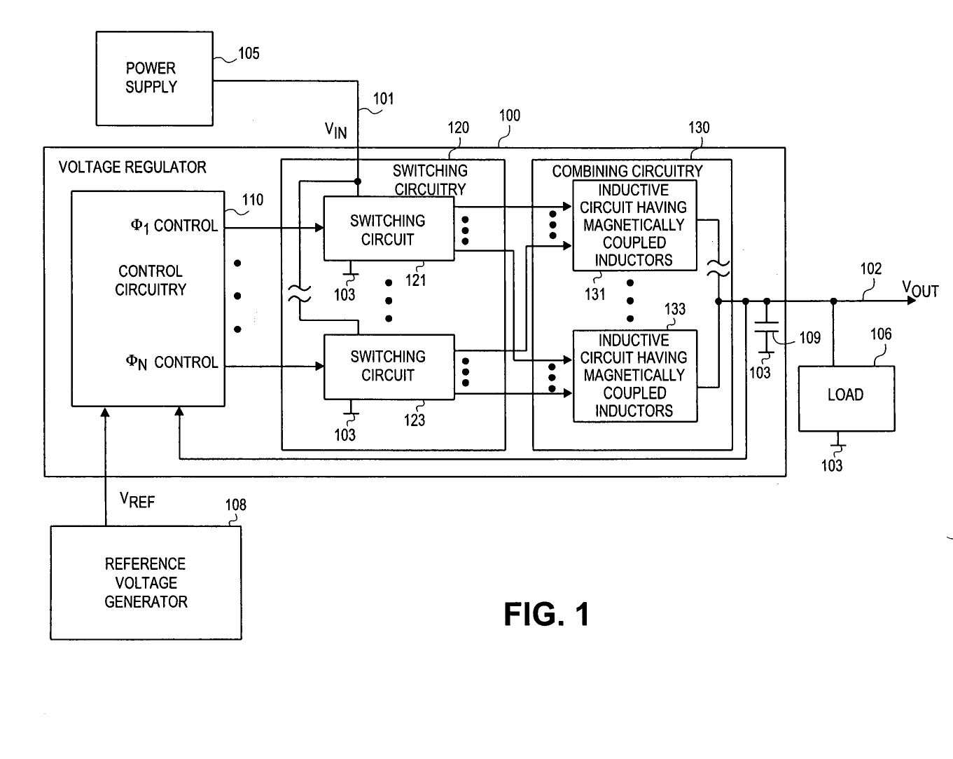

FIG. 1 illustrates, for one embodiment, a multiphase voltage regulator 100 having paralleled inductive circuits, such as inductive circuits 131 and 133 for example, having magnetically coupled inductors. Voltage regulator 100 may be coupled to a power supply 105 to receive an input supply voltage V_{IN} signal at a supply node 101 and supply a regulated output supply voltage V_{OUT} signal at an output node 102 to one or more circuits, represented by load 106. Voltage regulator 100 may be coupled to any suitable reference voltage supply, such as ground for example, to receive a reference supply voltage signal at a supply node 103. Voltage regulator 100 for one embodiment may be used for direct current (DC) voltage regulation.

Voltage regulator 100 for one embodiment may also be coupled to receive a reference voltage V_{REF} signal from a reference voltage generator 108 to supply a regulated output supply voltage V_{OUT} signal based on the reference voltage V_{REF} signal. Voltage regulator 100 for one embodiment may help supply a regulated output supply voltage V_{OUT} signal substantially equal to the reference voltage V_{REF} signal.

Voltage regulator 100 for one embodiment may help maintain the output supply voltage V_{OUT} signal at output node 102 despite the circuit(s) of load 106 drawing varying amounts of current from voltage regulator 100. Voltage regulator 100 for one embodiment may have paralleled inductive circuits having magnetically coupled inductors to help allow load 106 to draw relatively higher current through voltage regulator 100. Voltage regulator 100 for one embodiment may have paralleled inductive circuits having magnetically coupled inductors to help reduce current flow through separate devices of voltage regulator 100, helping to reduce and/or dissipate heat from voltage regulator 100 and/or helping to allow devices having lower current-carrying capacity to be used to implement voltage regulator 100.

Voltage Regulator

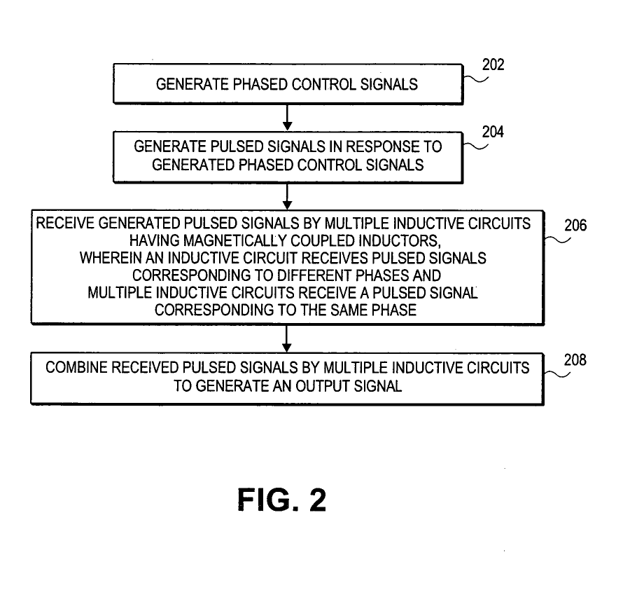

Voltage regulator 100 for one embodiment, as illustrated in FIG. 1, may comprise control circuitry 110, switching circuitry 120, and combining circuitry 130 and may operate in accordance with a flow diagram 200 of FIG. 2.

For block 202 of FIG. 2, control circuitry 110 may generate phased control signals. Control circuitry 110 may comprise any suitable circuitry to generate any suitable phased control signals in any suitable manner. Control circuitry 110 for one embodiment may be implemented at least partially on one or more integrated circuits.

Control circuitry 110 may generate any suitable number of control signals having any suitable number of phases. Control circuitry 110 for one embodiment, with reference to FIG. 1, may generate any suitable number of one or more control signals corresponding to each of N phases Φ₁-Φ_{N}, where N is an integer greater than one.

Control circuitry 110 for one embodiment may generate control signals having any suitable phase relationship relative to one another and/or to one or more reference signals. Control circuitry 110 for one embodiment may generate control signals having a substantially 360/N degree phase relationship relative to one or more other control signals and/or to one or more reference signals. As one example where N is equal to two, control circuitry 110 for one embodiment may generate one or more control signals having a substantially 180 degree phase relationship relative to one or more other control signals.

Control circuitry 110 may generate any suitable phased control signals to help regulate the output supply voltage V_{OUT} signal at output node 102. Control circuitry 110 for one embodiment may generate pulsed phased control signals and control a pulse duration and/or a duty cycle of such control signals to help regulate the output supply voltage V_{OUT} signal. Control circuitry 110 may generate such pulsed phased control signals with a pulse of any suitable shape.

Control circuitry 110 for one embodiment may be coupled to monitor the output supply voltage V_{OUT} signal to help control phased control signals. Control circuitry 110 for one embodiment may be coupled to monitor voltage and/or current at output node 102 to monitor the output supply voltage V_{OUT} signal. Control circuitry 110 for one embodiment may be coupled to receive the output supply voltage V_{OUT} signal and a reference voltage V_{REF} signal from reference voltage generator 108 and compare a voltage corresponding to the output supply voltage V_{OUT} signal to a reference voltage corresponding to the reference voltage V_{REF} signal to sense error in the output supply voltage V_{OUT} signal. Control circuitry 110 may then control phased control signals in response to the sensed error.

For block 204 of FIG. 2, switching circuitry 120 may generate pulsed signals in response to phased control signals generated for block 202. Switching circuitry 120 for one embodiment may be coupled to receive phased control signals from control circuitry 110. Switching circuitry 120 may comprise any suitable circuitry to generate any suitable number of any suitable pulsed signals in any suitable manner in response to phased control signals.

Switching circuitry 120 for one embodiment may be coupled to supply node 101 to receive the input supply voltage V_{IN} signal. Switching circuitry 120 for one embodiment may generate pulsed signals having an amplitude corresponding to the input supply voltage V_{IN} signal.

Switching circuitry 120 may generate any suitable pulsed signals having any suitable pulse shape to help regulate the output supply voltage V_{OUT} signal at output node 102. Switching circuitry 120 for one embodiment may generate pulsed signals having a pulse width and/or duty cycle based on phased control signals from control circuitry 110.

Switching circuitry 120 for one embodiment may comprise multiple switching circuits to generate corresponding sets of one or more pulsed signals. Switching circuitry 120 for one embodiment, as illustrated in FIG. 1, may comprise N switching circuits, such as switching circuits 121 and 123 for example, corresponding to N phases of control signals generated by control circuitry 110. A switching circuit for one embodiment may be coupled to receive one or more control signals corresponding to one of the N phases to generate a set of any suitable number of one or more pulsed signals corresponding to that one phase. A switching circuit for one embodiment may generate a set of multiple pulsed signals having substantially the same phase. A switching circuit for one embodiment may generate a set of multiple pulsed signals equal in number to inductive circuits of combining circuitry 130 that are to receive a pulsed signal from that switching circuit. A switching circuit for one embodiment may generate a set of multiple pulsed signals over respective output lines of the switching circuit.

Switching circuitry 120 for one embodiment may comprise switching circuits that may or may not be the same as or similar to one another. Switching circuitry 120 for one embodiment may comprise switching circuits all of which are the same as or similar to one another.

For block 206 of FIG. 2, multiple inductive circuits having magnetically coupled inductors may receive pulsed signals generated for block 204. An inductive circuit may receive pulsed signals corresponding to different phases, and multiple inductive circuits may receive a pulsed signal corresponding to the same phase. Multiple inductive circuits of combining circuitry 130 for one embodiment may be coupled to receive pulsed signals in this manner from switching circuitry 120.

Combining circuitry 130 for one embodiment may comprise an inductive circuit coupled to receive a pulsed signal from multiple switching circuits corresponding to different phases. Combining circuitry 130 for one embodiment may comprise an inductive circuit coupled to receive pulsed signals over respective input lines coupled to multiple switching circuits. Combining circuitry 130 for one embodiment may comprise multiple inductive circuits similarly coupled to receive pulsed signals from multiple switching circuits corresponding to different phases.

Combining circuitry 130 for one embodiment may comprise multiple inductive circuits coupled to receive a pulsed signal from a common switching circuit corresponding to one phase. Combining circuitry 130 for one embodiment may comprise multiple inductive circuits coupled to receive a pulsed signal over a respective output line from a common switching circuit corresponding to one phase. Combining circuitry 130 for one embodiment may comprise multiple inductive circuits similarly coupled to receive pulsed signals from multiple common switching circuits.

As one example, as illustrated in FIG. 1, inductive circuit 131 may be coupled to receive one pulsed signal from each of N switching circuits of switching circuitry 120, and inductive circuit 133 may be coupled to receive one pulsed signal from each of N switching circuits of switching circuitry 120. In this manner, inductive circuit 131 may be coupled to receive pulsed signals corresponding to N different phases; inductive circuit 133 may be coupled to receive pulsed signals corresponding to N different phases; and both inductive circuits 131 and 133 may be coupled to receive a pulsed signal corresponding to each of N phases.

Combining circuitry 130 may comprise any suitable number of inductive circuits to receive pulsed signals. The number of inductive circuits for one embodiment may depend, for example, on the amount of current that is to flow through such inductive circuits.

For block 208 of FIG. 2, multiple inductive circuits may combine pulsed signals received for block 206 to generate an output signal. Multiple inductive circuits of combining circuitry 130 may comprise any suitable magnetically coupled inductors and/or any other suitable circuitry and may be coupled in any suitable manner to combine received pulsed signals in any suitable manner to generate any suitable output signal.

Multiple inductive circuits of combining circuitry 130 for one embodiment may combine received pulsed signals to generate output pulsed signals at output node 102. An inductive circuit may comprise any suitable magnetically coupled inductors coupled in any suitable manner to help combine received pulsed signals to generate output pulsed signals at output node 102. Combining circuitry 130 for one embodiment may comprise multiple inductive circuits having magnetically coupled inductors to help provide an improved transient response with less stress on switching circuitry 120. Magnetically coupled inductors for one embodiment may be implemented using coupled inductors.

Combining circuitry 130 for one embodiment may comprise inductive circuits that may or may not be the same as or similar to one another. Combining circuitry 130 for one embodiment may comprise inductive circuits all of which are the same as or similar to one another.

Voltage regulator 100 for one embodiment may comprise any suitable one or more energy storing devices coupled to output node 102 to receive and store energy from output pulsed signals at output node 102. Load 106 may draw energy from such energy storing device(s) as such energy storing device(s) receive and store energy from output pulsed signals. Such energy storing device(s) for one embodiment may help voltage regulator 100 maintain the output supply voltage V_{OUT} signal at output node 102 as load 106 draws varying amounts of current from voltage regulator 100.

Voltage regulator 100 may comprise any suitable one or more energy storing devices. Voltage regulator 100 for one embodiment may comprise one or more capacitors, collectively represented by an output capacitor 109 in FIG. 1, coupled between output node 102 and supply node 103.

Because control circuitry 110 for one embodiment may be coupled to monitor voltage and/or current at output node 102, control circuitry 110, switching circuitry 120, and combining circuitry 130 for one embodiment may define a feedback loop to monitor the output supply voltage V_{OUT} signal to help control phased control signals as combining circuitry 130 combines received pulsed signals to generate the output supply voltage V_{OUT} signal. Control circuitry 110 may monitor the output supply voltage V_{OUT} signal and/or control phased control signals in response to such monitoring in accordance with any suitable scheme such as, for example, substantially continuously, discretely at any suitable rate, or in response to any suitable event.

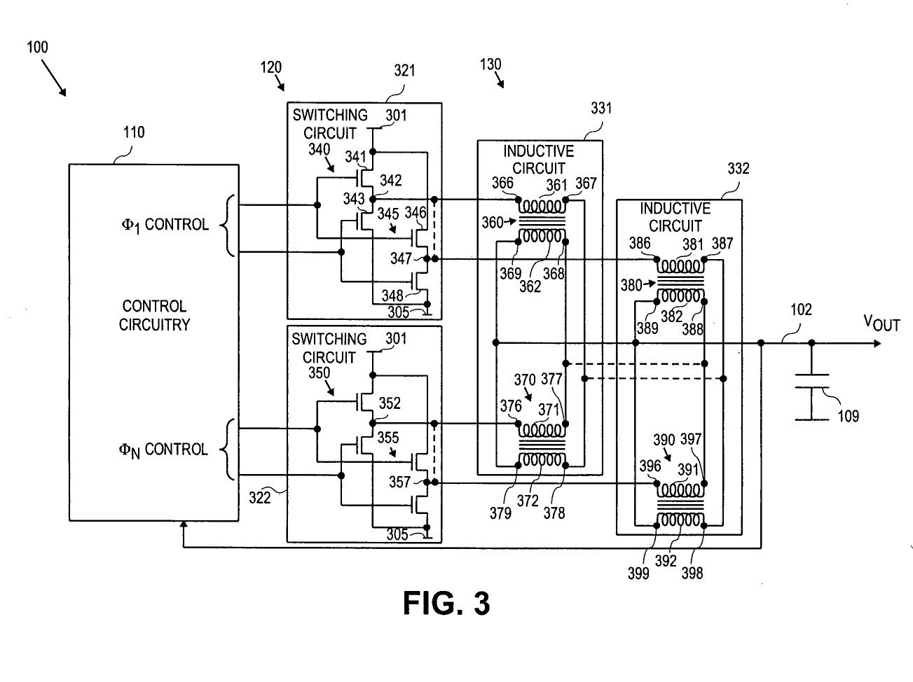

FIG. 3 illustrates, for one embodiment, example circuitry to implement switching circuitry 120 and combining circuitry 130 for voltage regulator 100 of FIG. 1. As illustrated in FIG. 3, switching circuitry 120 for one embodiment may comprise switching circuits 321 and 322 corresponding to first and second phases, respectively. Combining circuitry 130 for one embodiment may comprise an inductive circuit 331 to receive a pulsed signal corresponding to the first phase from switching circuit 321 and to receive a pulsed signal corresponding to the second phase from switching circuit 322. Combining circuitry 130 for one embodiment may also comprise an inductive circuit 332 to receive a pulsed signal corresponding to the first phase from switching circuit 321 and to receive a pulsed signal corresponding to the second phase from switching circuit 322.

Example Switching Circuitry

A switching circuit for one embodiment may comprise multiple switching devices to generate corresponding pulsed signals in response to one or more phased control signals generated by control circuitry 110. Having multiple switching devices to implement a switching circuit for one embodiment may help allow load 106 to draw relatively higher current through the switching circuit. Having multiple switching devices to implement a switching circuit for one embodiment may help reduce current flow through any one switching device, helping to reduce and/or dissipate heat from the switching circuit and/or helping to allow switching devices having lower current-carrying capacity to be used.

A switching circuit for one embodiment may comprise any suitable switching devices. A switching device for one embodiment may comprise a pull-up transistor and/or a pull-down transistor to generate a corresponding pulsed signal in response to one or more phased control signals generated by control circuitry 110. Such transistor(s) for one embodiment may be field effect transistors (FETs).

A switching circuit for one embodiment may comprise switching devices that may or may not be the same as or similar to one another. A switching circuit for one embodiment may comprise switching devices all of which are the same as or similar to one another.

For one example, as illustrated in FIG. 3, switching circuit 321 for one embodiment may comprise a switching device 340 comprising a pull-up transistor 341 which may be coupled to be activated and deactivated in response to a first control signal corresponding to the first phase and a pull-down transistor 343 which may be coupled to be activated and deactivated in response to a second control signal corresponding to the first phase.

Pull-up transistor 341 may be coupled between a supply node 301 and an output node 342 to help couple output node 342 to supply node 301 when activated and to decouple output node 342 from supply node 301 when deactivated. Pull-down transistor 343 may be coupled between output node 342 and a supply node 305 to help couple output node 342 to supply node 305 when activated and to decouple output node 342 from supply node 301 when deactivated. Supply node 301 for one embodiment may correspond to supply node 101 of FIG. 1, and supply node 305 for one embodiment may correspond to supply node 103 of FIG. 1.

For one embodiment, control circuitry 110 may generate the first and second control signals corresponding to the first phase to activate pull-up transistor 341 and pull-down transistor 343 in a substantially alternate manner to generate at output node 342 a pulsed signal corresponding to the first phase.

Switching circuit 321 for one embodiment may also comprise a switching device 345 comprising a pull-up transistor 346 which may also be coupled to be activated and deactivated in response to the first control signal corresponding to the first phase and a pull-down transistor 348 which may also be coupled to be activated and deactivated in response to the second control signal corresponding to the first phase.

Pull-up transistor 346 may be coupled between supply node 301 and an output node 347 to help couple output node 347 to supply node 301 when activated and to decouple output node 347 from supply node 301 when deactivated. Pull-down transistor 348 may be coupled between output node 347 and a supply node 305 to help couple output node 347 to supply node 305 when activated and to decouple output node 347 from supply node 301 when deactivated. Supply node 301 for one embodiment may correspond to supply node 101 of FIG. 1, and supply node 305 for one embodiment may correspond to supply node 103 of FIG. 1.

For one embodiment, control circuitry 110 may generate the first and second control signals corresponding to the first phase to also activate pull-up transistor 346 and pull-down transistor 348 in a substantially alternate manner to generate at output node 347 another pulsed signal corresponding to the first phase.

Control circuitry 110 for one embodiment, as illustrated in FIG. 3, may generate the first and second control signals corresponding to the first phase as substantially complementary signals to activate a pull-up n-channel field effect transistor (nFET) and a pull-down nFET in a substantially alternate manner to generate a pulsed signal. Control circuitry 110 for one embodiment may generate the first and second control signals in such a manner as to help avoid having both nFETs activated simultaneously. Control circuitry 110 and/or switching circuit 321 for another embodiment may be implemented using alternative logic to generate a pulsed signal.

Switching circuit 322 for one embodiment may comprise two switching devices 350 and 355 to generate two pulsed signals corresponding to the second phase at output nodes 352 and 357. Switching devices 350 and 355 for one embodiment may be implemented similarly as switching devices 340 and 345.

For one embodiment, outputs of switching devices of a switching circuit may optionally be coupled to one another. For one embodiment, as illustrated in FIG. 3, switching devices 340 and 345 may optionally be coupled at output nodes 342 and 347, and switching devices 350 and 355 may optionally be coupled at output nodes 352 and 357.

Although illustrated as having two switching circuits 321 and 322 each having two switching devices 340, 345 and 350, 355, switching circuitry 120 for another embodiment may comprise any suitable number of switching circuits each having any suitable number of switching devices. The number of switching circuits for one embodiment may correspond to the number of phases for which the switching circuits are to generate pulsed signals. The number of switching devices of a switching circuit for one embodiment may depend, for example, on the amount of current that is to flow through such switching devices. The number of switching devices of a switching circuit for one embodiment may correspond to the number of inductive circuits that are to receive a pulsed signal from that switching circuit.

Example Combining Circuitry

Combining circuitry 130 for one embodiment may comprise multiple inductive circuits to help allow load 106 to draw relatively higher current through combining circuitry 130. Combining circuitry 130 for one embodiment may comprise multiple inductive circuits to help allow load 106 to draw relatively higher current without increasing the number of phases for voltage regulator 100.

Combining circuitry 130 for one embodiment may comprise multiple inductive circuits to help reduce current flow through any one inductive circuit, helping to reduce and/or dissipate heat from combining circuitry 130 and/or helping to allow combining circuitry 130 to be implemented using devices having lower current-carrying capacity.

An inductive circuit for one embodiment may comprise multiple inductive devices to receive corresponding pulsed signals corresponding to different phases. An inductive device for one embodiment may receive a pulsed signal from a respective switching circuit.

An inductive circuit for one embodiment may comprise any suitable inductive devices. An inductive device for one embodiment may comprise a pair of inductors that are magnetically coupled. Inductors of an inductive device may be implemented in any suitable manner and may have any suitable inductance. Inductors of an inductive device may or may not be similarly implemented. Inductors of an inductive device may or may not have the same inductance. Inductors of an inductive device may be magnetically coupled in any suitable manner. Inductors of an inductive device for one embodiment may be coupled inductors. Inductors of an inductive device for one embodiment may share a common core of any suitable material such as, for example, ferrite.

An inductive circuit for one embodiment may comprise inductive devices that may or may not be the same as or similar to one another. An inductive circuit for one embodiment may comprise inductive devices all of which are the same as or similar to one another.

For one example, as illustrated in FIG. 3, inductive circuit 331 for one embodiment may comprise an inductive device 360 comprising inductors 361 and 362 that are magnetically coupled. Inductor 361 may be coupled to receive a pulsed signal corresponding to the first phase from switching device 340 and induce current flow through inductor 362. Inductive circuit 331 for one embodiment may also comprise an inductive device 370 comprising inductors 371 and 372 that are magnetically coupled. Inductor 371 may be coupled to receive a pulsed signal corresponding to the second phase from switching device 350 and induce current flow through inductor 372.

Inductive devices 360 and 370 may be coupled in any suitable manner to help generate the output supply voltage V_{OUT} signal. For one embodiment, as illustrated in FIG. 3, inductor 361 may be coupled in series with inductor 372 and inductor 371 may be coupled in series with inductor 362. Inductor 361 may have an end 366 coupled to receive a pulsed signal from switching device 340 and another end 367 coupled to an end 378 of inductor 372. Inductor 372 may have another end 379 coupled to output node 102. Inductor 371 may have an end 376 coupled to receive a pulsed signal from switching device 350 and another end 377 coupled to an end 368 of inductor 362. Inductor 362 may have another end 369 coupled to output node 102.

Inductive circuit 332 for one embodiment may comprise an inductive device 380 comprising inductors 381 and 382 that are magnetically coupled. Inductor 381 may be coupled to receive a pulsed signal corresponding to the first phase from switching device 345 and induce current flow through inductor 382. Inductive circuit 332 for one embodiment may also comprise an inductive device 390 comprising inductors 391 and 392 that are magnetically coupled. Inductor 391 may be coupled to receive a pulsed signal corresponding to the second phase from switching device 355 and induce current flow through inductor 392.

Inductive devices 380 and 390 may be coupled in any suitable manner to help generate the output supply voltage V_{OUT} signal. For one embodiment, as illustrated in FIG. 3, inductor 381 may be coupled in series with inductor 392 and inductor 391 may be coupled in series with inductor 382. Inductor 381 may have an end 386 coupled to receive a pulsed signal from switching device 340 and another end 387 coupled to an end 398 of inductor 392. Inductor 392 may have another end 399 coupled to output node 102. Inductor 391 may have an end 396 coupled to receive a pulsed signal from switching device 350 and another end 397 coupled to an end 388 of inductor 382. Inductor 382 may have another end 389 coupled to output node 102.

For one embodiment, inductive devices of an inductive circuit may optionally be coupled to inductive devices of another inductive circuit. For one embodiment, as illustrated in FIG. 3, inductive devices 360, 370, 380, and 390 may optionally be coupled to one another other than at output node 102. Inductor ends 368, 377, 388, and 397, for example, may optionally be coupled. Inductor ends 367, 378, 387, and 398, for example, may optionally be coupled. Inductor ends 366 and 386 may optionally be coupled. Coupling inductor ends 366 and 386 for one embodiment may effectively couple output nodes of switching devices 340 and 345. Inductor ends 376 and 396 may optionally be coupled. Coupling inductor ends 376 and 396 for one embodiment may effectively couple output nodes of switching devices 350 and 355.

Although illustrated as having two inductive circuits 331 and 332 each having two inductive devices 360, 370 and 380, 390, combining circuitry 130 for another embodiment may comprise any suitable number of inductive circuits each having any suitable number of inductive devices. The number of inductive circuits for one embodiment may depend, for example, on the amount of current that is to flow through such inductive circuits. The number of inductive devices of an inductive circuit for one embodiment may correspond to the number of phases for which the inductive circuit is to receive pulsed signals.

Example Waveforms

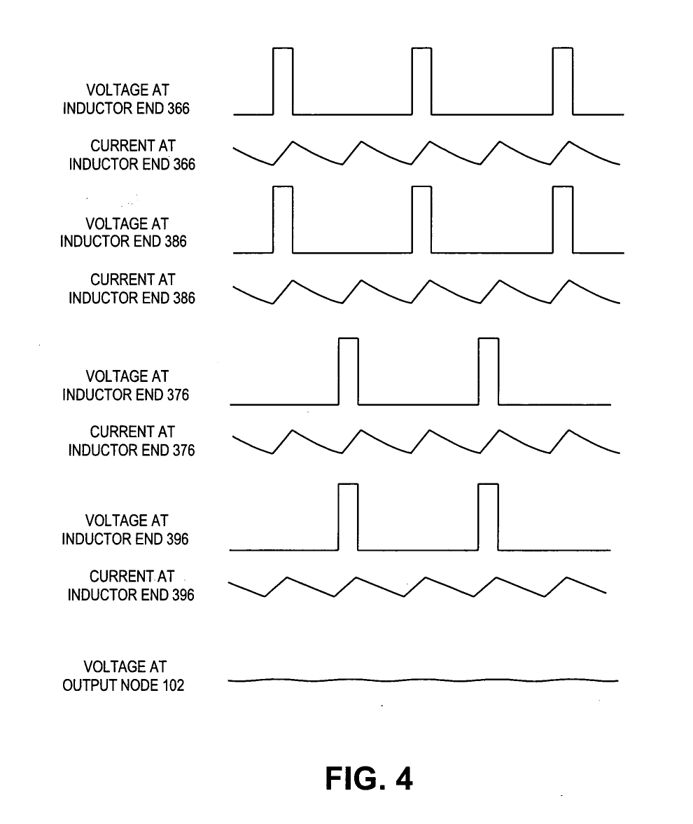

FIG. 4 illustrates, for one embodiment, a waveform diagram 400 of example signal waveforms for the example circuitry to implement switching circuitry 120 and combining circuitry 130 as illustrated in FIG. 3. As illustrated in FIG. 4, waveform diagram 400 shows example voltage and current waveforms at inductor ends 366, 386, 376, and 396 of FIG. 3 and an example voltage waveform at output node 102.

As illustrated in FIG. 4, inductive devices 360 and 380 may receive from switching circuit 321 a pulsed signal corresponding to a first phase at inductor ends 366 and 386, and inductive devices 370 and 390 may receive from switching circuit 322 a pulsed signal corresponding to a second phase at inductor ends 376 and 396. The first and second phases for the example waveforms in FIG. 4 may be offset by substantially 180 degrees. The voltage waveform at output node 102 may result from charging output capacitor 109 with the combined pulsed signals generated by combining circuitry 130 at output node 102.

Another Example Switching and Combining Circuitry

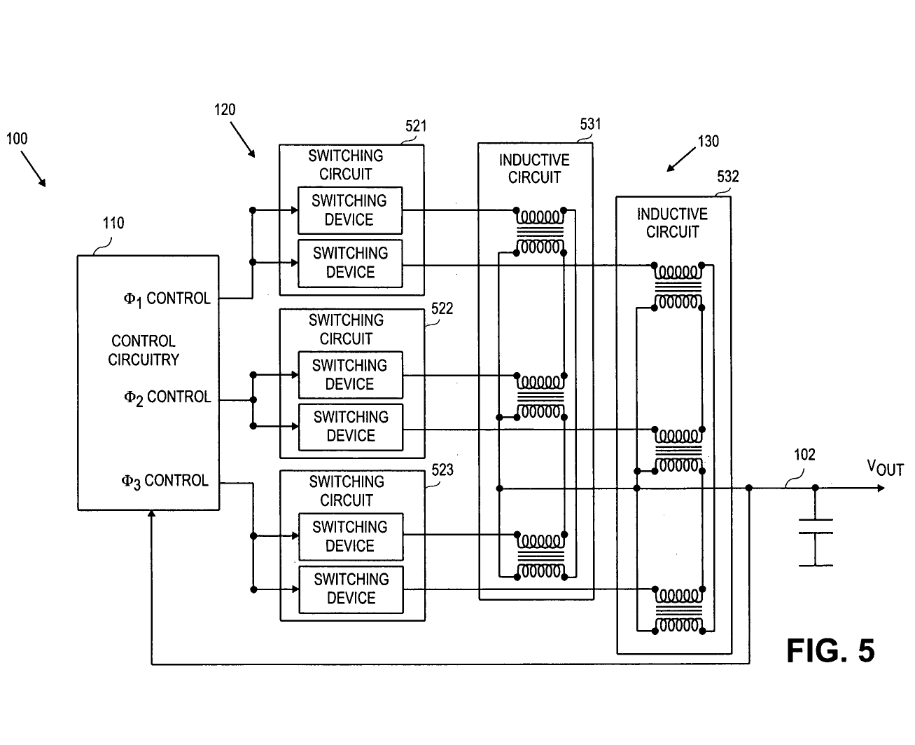

FIG. 5 illustrates, for one embodiment, example circuitry to implement switching circuitry 120 and combining circuitry 130 for voltage regulator 100 of FIG. 1.

As illustrated in FIG. 5, switching circuitry 120 for one embodiment may comprise three switching circuits 521, 522, and 523 corresponding to three phases of control signals generated by control circuitry 110. Switching circuit 521 for one embodiment may comprise two switching devices to generate two pulsed signals corresponding to a first phase. Switching circuit 522 for one embodiment may comprise two switching devices to generate two pulsed signals corresponding to a second phase. Switching circuit 523 for one embodiment may comprise two switching devices to generate two pulsed signals corresponding to a third phase.

Combining circuitry 130 for one embodiment may comprise two inductive circuits 531 and 532. Inductive circuit 531 for one embodiment may comprise three coupled inductors respectively coupled to receive a pulsed signal from switching circuit 521, a pulsed signal from switching circuit 522, and a pulsed signal from switching circuit 523. Inductive circuit 532 for one embodiment may comprise three coupled inductors respectively coupled to receive a pulsed signal from switching circuit 521, a pulsed signal from switching circuit 522, and a pulsed signal from switching circuit 523.

Example Control Circuitry

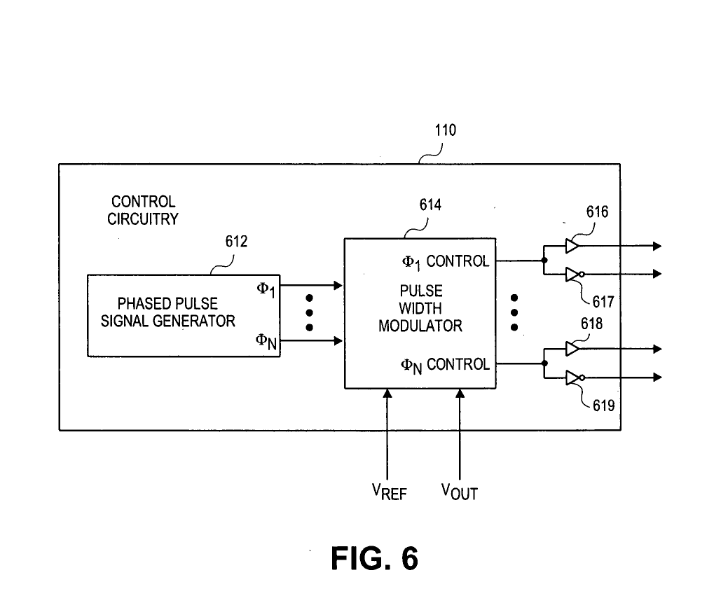

FIG. 6 illustrates, for one embodiment, example circuitry to implement control circuitry 110 for the voltage regulator of FIG. 1. As illustrated in FIG. 6, control circuitry 110 for one embodiment may comprise a phased pulse signal generator 612 and a pulse width modulator 614.

Phased pulse signal generator 612 may comprise any suitable circuitry to generate any suitable phased pulse signals in any suitable manner. Phased pulse signal generator 612 for one embodiment may derive multiple phased pulse signals from a single clock signal.

Pulse width modulator 614 for one embodiment may be coupled to receive phased pulse signals from phased pulse signal generator 612 and the output supply voltage V_{OUT} signal at output node 102. Pulse width modulator 614 for one embodiment may comprise any suitable circuitry to adjust the width or duration of received pulse signals based on sensed error in the output supply voltage V_{OUT} signal to generate phased control signals to help regulate the output supply voltage V_{OUT} signal. Pulse width modulator 614 for one embodiment may be coupled to receive the reference voltage V_{REF} signal from reference voltage generator 108 and compare a voltage corresponding to the output supply voltage V_{OUT} signal to a reference voltage corresponding to the reference voltage V_{REF} signal to sense error in the output supply voltage V_{OUT} signal.

Control circuitry 110 for one embodiment may comprise additional circuitry to derive multiple phased control signals from a phased control signal generated by pulse width modulator 614. Control circuitry 110 for one embodiment may comprise any suitable circuitry to generate substantially complementary signals from a phased control signal generated by pulse width modulator 614. As illustrated in FIG. 6, control circuitry 110 for one embodiment may comprise, for example, an inverter 617 coupled to receive a first phased control signal to generate substantially complementary signals corresponding to a first phase and an inverter 619 coupled to receive an Nth phased control signal to generate substantially complementary signals corresponding to an Nth phase.

For one embodiment where switching circuitry 120 comprises paired pull-up and pull-down transistors to generate a pulsed signal in response to substantially complementary phased control signals, control circuitry 110 for one embodiment may comprise any suitable circuitry to generate substantially complementary signals in such a manner as to help avoid activating paired pull-up and pull-down transistors simultaneously. As illustrated in FIG. 6, control circuitry 110 for one embodiment may comprise, for example, a buffer 616 coupled to receive the first phased control signal and a buffer 618 coupled to receive the Nth phased control signal. Buffer 616 and inverter 617 for one embodiment may be designed to help delay transitions in their resulting signals to help avoid activating paired pull-up and pull-down transistors simultaneously. Buffer 618 and inverter 619 for one embodiment may be designed to help delay transitions in their resulting signals to help avoid activating paired pull-up and pull-down transistors simultaneously.

Example Application

Voltage regulator 100 may be used for any suitable purpose. Voltage regulator 100 for one embodiment may be used as a voltage converter. Voltage regulator 100 for one embodiment may be used as a DC-DC converter. Voltage regulator 100 for one embodiment may convert the input supply voltage V_{IN} signal from power supply 105 to supply a different output supply voltage V_{OUT} signal to load 106.

Voltage regulator 100 for one embodiment may be used as a buck converter. Voltage regulator 100 for one embodiment may convert a supply voltage signal having a higher voltage into one having a lower voltage. The circuit(s) of load 106 for one embodiment may be designed to operate using a lower supply voltage signal to help reduce power consumption.

Voltage regulator 100 for one embodiment may be used to supply a regulated output supply voltage V_{OUT} signal to any suitable one or more integrated circuits for use in any suitable system. Voltage regulator 100 for one embodiment may be external to such integrated circuit(s). Voltage regulator 100 for one embodiment may be supported on the same circuit board on which such integrated circuit(s) are supported.

Voltage regulator 100 for one embodiment may be used to supply a regulated output supply voltage V_{OUT} signal to one or more integrated circuits forming at least a portion of any suitable processor for use, for example, in any suitable computer system and/or control system.

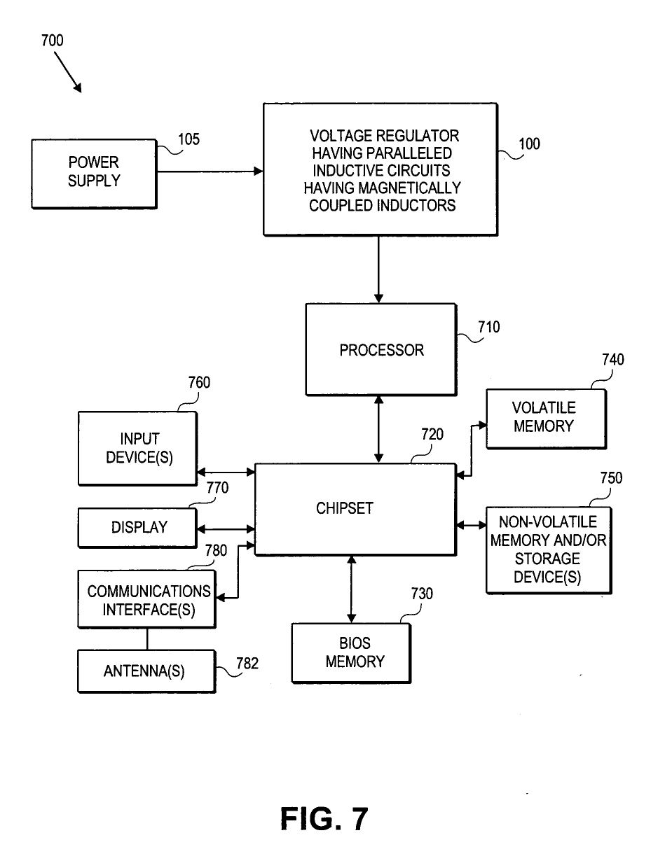

FIG. 7 illustrates, for one embodiment, an example system 700 comprising voltage regulator 100 coupled to power supply 105 to supply a regulated output supply voltage signal to a processor 710. Voltage regulator 100 may be used to supply a regulated output supply voltage signal for use by all or any suitable one or more portions of one or more integrated circuits of processor 710.

As used in system 700, power supply 105 for one embodiment may comprise a battery. Power supply 105 for another embodiment may comprise an alternating current to direct current (AC-DC) converter. Power supply 105 for another embodiment may comprise a DC-DC converter.

As illustrated in FIG. 7, system 700 also comprises a chipset 720 coupled to processor 710, a basic input/output system (BIOS) memory 730 coupled to chipset 720, volatile memory 740 coupled to chipset 720, non-volatile memory and/or storage device(s) 750 coupled to chipset 720, one or more input devices 760 coupled to chipset 720, a display 770 coupled to chipset 720, and one or more communications interfaces 780 coupled to chipset 720.

Chipset 720 for one embodiment may comprise any suitable interface controllers to provide for any suitable communications link to processor 710 and/or to any suitable device or component in communication with chipset 720.

Chipset 720 for one embodiment may comprise a firmware controller to provide an interface to BIOS memory 730. BIOS memory 730 may be used to store any suitable system and/or video BIOS software for system 700. BIOS memory 730 may comprise any suitable non-volatile memory, such as a suitable flash memory for example. BIOS memory 730 for one embodiment may alternatively be included in chipset 720.

Chipset 720 for one embodiment may comprise one or more memory controllers to provide an interface to volatile memory 740. Volatile memory 740 may be used to load and store data and/or instructions, for example, for system 700. Volatile memory 740 may comprise any suitable volatile memory, such as suitable dynamic random access memory (DRAM) for example.

Chipset 720 for one embodiment may comprise one or more input/output (I/O) controllers to provide an interface to non-volatile memory and/or storage device(s) 750, input device(s) 760, and communications interface(s) 780. Non-volatile memory and/or storage device(s) 750 may be used to store data and/or instructions, for example. Non-volatile memory and/or storage device(s) 750 may comprise any suitable non-volatile memory, such as flash memory for example, and/or may comprise any suitable non-volatile storage device(s), such as one or more hard disk drives (HDDs), one or more compact disc (CD) drives, and/or one or more digital versatile disc (DVD) drives for example. Input device(s) 760 may comprise any suitable input device(s), such as a keyboard, a mouse, and/or any other suitable cursor control device. Communications interface(s) 780 provide an interface for system 700 to communicate over one or more networks and/or with any other suitable device. Communications interface(s) 780 may comprise any suitable hardware and/or firmware. Communications interface(s) 780 for one embodiment may comprise, for example, a network adapter, a wireless network adapter, a telephone modem, and/or a wireless modem. For wireless communications, communications interface(s) 780 for one embodiment may use one or more antennas 782.

Chipset 720 for one embodiment may comprise a graphics controller to provide an interface to display 770. Display 770 may comprise any suitable display, such as a cathode ray tube (CRT) or a liquid crystal display (LCD) for example. The graphics controller for one embodiment may alternatively be external to chipset 720.

Although described as residing in chipset 720, one or more controllers of chipset 720 may be integrated with processor 710, allowing processor 710 to communicate with one or more devices or components directly. As one example, one or more memory controllers for one embodiment may be integrated with one or more of processor 710, allowing processor 710 to communicate with volatile memory 740 directly.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
switching circuitry to generate pulsed signals in response to phased control signals; and
multiple inductive circuits having magnetically coupled inductors, the multiple inductive circuits coupled to receive and combine pulsed signals from the switching circuitry to generate an output signal,
wherein an inductive circuit is to receive pulsed signals corresponding to different phases, and
wherein multiple inductive circuits are to receive a pulsed signal corresponding to the same phase.

2. The apparatus of claim 1, wherein an inductive circuit includes multiple inductive devices to receive corresponding pulsed signals corresponding to different phases, and
wherein an inductive device has a pair of inductors that are magnetically coupled.

3. The apparatus of claim 2, wherein multiple inductive devices include coupled inductors.

4. The apparatus of claim 1, comprising:
control circuitry to generate phased control signals.

5. The apparatus of claim 4, wherein the control circuitry is to monitor the output signal to help control phased control signals.

6. The apparatus of claim 1, wherein the switching circuitry includes multiple pull-up and pull-down transistors to generate pulsed signals.

7. An apparatus comprising:
a first switching circuit to generate a first pulsed signal and a second pulsed signal in response to one or more control signals corresponding to a first phase;
a second switching circuit to generate a third pulsed signal and a fourth pulsed signal in response to one or more control signals corresponding to a second phase; and
combining circuitry to generate an output signal at an output node, the combining circuitry including a first inductive circuit having magnetically coupled inductors to receive the first pulsed signal and the third pulsed signal and a second inductive circuit having magnetically coupled inductors to receive the second pulsed signal and the fourth pulsed signal, wherein the first and second inductive circuits are coupled to the output node.

8. The apparatus of claim 7, wherein the first inductive circuit includes a first inductive device to receive the first pulsed signal and a second inductive device to receive the third pulsed signal, wherein the first inductive device has a pair of inductors that are magnetically coupled and wherein the second inductive device has a pair of inductors that are magnetically coupled.

9. The apparatus of claim 8, wherein the second inductive circuit includes a third inductive device to receive the second pulsed signal and a fourth inductive device to receive the fourth pulsed signal, wherein the third inductive device has a pair of inductors that are magnetically coupled and wherein the fourth inductive device has a pair of inductors that are magnetically coupled.

10. The apparatus of claim 9, wherein the first, second, third, and fourth inductive devices are coupled inductors.

11. The apparatus of claim 7, wherein the first inductive circuit includes a first inductor coupled in series with a second inductor and includes a third inductor coupled in series with a fourth inductor, wherein the first and third inductors are magnetically coupled, and wherein the second and fourth inductors are magnetically coupled.

12. The apparatus of claim 11, wherein the second inductive circuit includes a fifth inductor coupled in series with a sixth inductor and includes a seventh inductor coupled in series with an eighth inductor, wherein the fifth and seventh inductors are magnetically coupled, and wherein the sixth and eighth inductors are magnetically coupled.

13. The apparatus of claim 12, wherein the first and third inductors, the second and fourth inductors, the fifth and seventh inductors, and the sixth and eighth inductors are coupled inductors.

14. The apparatus of claim 7, comprising control circuitry to generate one or more control signals corresponding to the first phase and one or more control signals corresponding to the second phase.

15. The apparatus of claim 14, wherein the control circuitry is to monitor the output signal to help control the one or more control signals corresponding to the first phase and the one or more control signals corresponding to the second phase.

16. The apparatus of claim 7, wherein the first switching circuit includes first pull-up and pull-down transistors to generate the first pulsed signal and second pull-up and pull-down transistors to generate the second pulsed signal.

17. A method comprising:
generating phased control signals;
generate pulsed signals in response to generated phased control signals;
receiving generated pulsed signals by multiple inductive circuits having magnetically coupled inductors, the receiving including receiving by an inductive circuit pulsed signals corresponding to different phases and receiving by multiple inductive circuits a pulsed signal corresponding to the same phase; and
combining received pulsed signals by multiple inductive circuits to generate an output signal.

18. The method of claim 17, wherein receiving by an inductive circuit pulsed signals corresponding to different phases includes receiving by multiple inductive devices corresponding pulsed signals corresponding to different phases, and
wherein an inductive device has a pair of inductors that are magnetically coupled.

19. The method of claim 17, comprising monitoring the output signal, wherein generating phased control signals comprises controlling phased control signals in response to the monitored output signal.

20. A system comprising:
a battery;
a voltage regulator to receive an input supply voltage signal from the battery to generate a regulated output supply voltage signal, the voltage regulator including control circuitry to generate phased control signals, switching circuitry to generate pulsed signals in response to generated phased control signals, and paralleled inductive circuits having magnetically coupled inductors, the inductive circuits coupled to receive and combine pulsed signals from the switching circuitry to generate the output supply voltage signal,
wherein an inductive circuit is to receive pulsed signals corresponding to different phases and wherein multiple inductive circuits are to receive a pulsed signal corresponding to the same phase; and
one or more integrated circuits to receive the output supply voltage signal.

21. The system of claim 20, wherein an inductive circuit includes multiple inductive devices to receive corresponding pulsed signals corresponding to different phases, and
wherein an inductive device has a pair of inductors that are magnetically coupled.

22. The system of claim 21, wherein multiple inductive devices include coupled inductors.

23. The system of claim 20, wherein the control circuitry is to monitor the output signal to help control phased control signals.

24. The system of claim 20, wherein one or more integrated circuits to receive the output supply voltage signal form at least a portion of a processor.

25. The system of claim 24, comprising one or more communications interfaces and one or more antennas.
